(19) United States
(12) Patent Application Publication
(10) Pub. No.: US 2015/0109629 A1
(43) Pub. Date: Apr. 23, 2015

(54) IMAGE FORMING APPARATUS CAPABLE OF RESETTING SECURITY POLICY, METHOD OF CONTROLLING THE SAME, AND STORAGE MEDIUM

(71) Applicant: CANON KABUSHIKI KAISHA, Tokyo (JP)

(72) Inventor: Kyohei Takeda, Kawasaki-shi (JP)

(21) Appl. No.: 14/511,565

(22) Filed: Oct. 10, 2014

(30) Foreign Application Priority Data
Oct. 18, 2013 (JP) 2013-217689

(51) Int. Cl. H04N 1/44; H04L 29/06

(52) U.S. Cl. CPC H04N 1/4433; H04L 63/20; H04N 2201/0094
USPC 358/1.13

(57) ABSTRACT

An image forming apparatus which makes it possible, even when a security policy which is made unresettable is set, to reset the security policy via a network. An image forming apparatus receives an access request from a client PC. The received access request is analyzed, and when it is determined based on a result of analysis that the received access request is a request for finalizing a change to a security policy which is made unresettable, a second port which is different from a first port being currently used is opened to thereby make it possible to reset the security policy via a network.

### BACKGROUND OF THE INVENTION

1. Field of the Invention

The present invention relates to an image forming apparatus that is capable of resetting a security policy, a method of controlling the same, and a storage medium, and more particularly to a technique for distributing a security policy in a network environment.

2. Description of the Related Art

It is desirable that personal computers (PCs), and server apparatuses, such as a file server and an authentication server, connected to a network of e.g. an office are operated according to an information security policy determined on an office-by-office basis. The information security policy is a basic policy concerning the information security of the whole company, which is formed by compiling policies associated with usage of information and policies for preventing invasion from the outside and leakage of information, and is planned e.g. by an administrator in charge of security.

Examples of the apparatus connected to a network of an office include peripheral apparatuses, such as multifunction peripherals, in addition to the PCs and the server apparatuses. Some recent multifunction peripherals are configured not only to simply print and transmit images, but also to store image data therein, and provide a file service function to PCs, and thereby play the same role as the other server apparatuses existing on the network. Further, in recent years, a development environment of applications to be installed in a multifunction peripheral is open to the public, whereby applications developed by third parties are used, similarly to the cases of PCs.

To maintain a safe and secure office environment, each multifunction peripheral is also requested to comply with the information security policy, similarly to the PCs and the server apparatuses. Complying with the information security policy, mentioned here, is intended to mean providing restrictions on operations so as to prevent unauthorized use of the multifunction peripheral and information leakage from the office, e.g. by making user authentication an absolute requirement of operating the multifunction peripheral.

To make an apparatus compliant with the information security policy, there has been proposed a method of collectively setting setting values concerning security dependent on an operating system (OS) (a set of setting values concerning security is hereafter also referred to as “a security policy”) and distributing the set security polity, for the PCs and the server apparatuses. Examples of a setting value concerning encryption of a communication path dependent on the OS (each individual setting value is hereafter also referred to as “a policy”) include “permit non-SSL connection”, and unified management is performed to cause PCs provided by any vender to comply with the information security policy.

In multifunction peripherals, items which can be set concerning security are different depending on each multifunctional peripheral, and hence the setting values dependent on the OS cannot be directly distributed as the security policy as in the case of the PCs and the server apparatus. To cope with this, there has been proposed a system that configures security settings of each device based on a rule provided on a device-by-device basis such that the security settings are compliant with a security policy (see e.g. Japanese Patent Laid-Open Publication No. 2008-219419). Further, a security policy can be set not only by collective distribution from a distribution server, but also by individually accessing multifunction peripherals from a screen displayed on a Web browser of a PC.

In the above-mentioned conventional technique, an HTTP protocol is mainly used as a communication protocol for setting the security policy. Therefore, if a policy “inhibit HTTP connection” is set, it is impossible to perform distribution of a security policy from a server or individually set the same from the Web browser. This problem can be coped with by providing each multifunction peripheral with a function for changing the security policy from a display panel thereof.

However, a case can be anticipated where a security administrator manages a plurality of devices from a network outside the office, and in this case, it is difficult to individually reset the security policy in all of the devices. In view of this inconvenience, there is a demand for a function for resetting a security policy even from a remote location via a network.

### SUMMARY OF THE INVENTION

The present invention provides a technique for security policy distribution, which makes it possible, even when a security policy which is made unresettable is set, to reset the security policy via a network.

In a first aspect of the present invention, there is provided an image forming apparatus comprising a reception unit configured to receive an access request from an outside, a first analysis unit configured to analyze the access request received by the reception unit, and a control unit configured to open a second port which is different from a first port currently used by the reception unit, in a case where it is determined by the first analysis unit that the access request is a request for finalizing a change to a security policy which is made unresettable.

In a second aspect of the present invention, there is provided an image forming apparatus comprising a reception unit configured to receive an access request from an outside, a first analysis unit configured to analyze the access request received by the reception unit, and a control unit configured to acquire a security policy which is resettable from the outside, in a case where it is determined by the first analysis unit that the access request is a request for finalizing a change to a security policy which is made unresettable.

In a third aspect of the present invention, there is provided a method of controlling an image forming apparatus comprising receiving an access request from an outside, analyzing the access request received by said receiving, and opening a port which is different from a port currently used by said receiving, in a case where it is determined by said analyzing that the access request is a request for finalizing a change to a security policy which is made unresettable.

In a fourth aspect of the present invention, there is provided a method of controlling an image forming apparatus comprising receiving an access request from an outside, analyzing the access request received by said receiving, and acquiring a security policy which is resettable from the outside, in a case where it is determined by said analyzing that the access request is a request for finalizing a change to a security policy which is made unresettable.

In a fifth aspect of the present invention, there is provided a non-transitory computer-readable storage medium storing a computer-executable program for executing a method of controlling an image forming apparatus, wherein the method comprises receiving an access request from an outside, analyzing the access request received by said receiving, and opening a port which is different from a port currently used by said receiving, in a case where it is determined by said analyzing that the access request is a request for finalizing a change to a security policy which is made unresettable.

In a sixth aspect of the present invention, there is provided a non-transitory computer-readable storage medium storing a computer-executable program for executing a method of controlling an image forming apparatus, wherein the method comprises receiving an access request from an outside, analyzing the access request received by said receiving, and acquiring a security policy which is resettable from the outside, in a case where it is determined by said analyzing that the access request is a request for finalizing a change to a security policy which is made unresettable.

According to the present invention, even when a policy that disables resetting of a security policy is set, the image forming apparatus is accessed using an emergency port set in advance. This makes it possible, even when the policy that disables resetting of the security policy is set, to reset the security policy including the policy via the network.

Further features of the present invention will become apparent from the following description of exemplary embodiments (with reference to the attached drawings).

### BRIEF DESCRIPTION OF THE DRAWINGS

FIG. 1 is a diagram showing an example of a network environment in which an image forming apparatus according to a first embodiment of the present invention is installed.

FIG. 2 is a block diagram of the hardware configuration of the image forming apparatus appearing in FIG. 1.

FIG. 3 is a block diagram of the software configuration of the image forming apparatus.

FIG. 4 is a sequence diagram of operations performed between a client PC and the image forming apparatus, when the client PC accesses the image forming apparatus to change settings of a security policy.

FIG. 5 is a flowchart of an HTTP access control process performed by an HTTP access controller of the image forming apparatus.

FIG. 6 is a flowchart of a security policy control process performed by a security policy controller of the image forming apparatus.

FIG. 7 is a diagram showing an example of a login screen displayed on a Web browser of the client PC, before logging into the image forming apparatus.

FIG. 8 is a diagram showing an example of a setting registration screen displayed on the Web browser of the client PC.

FIG. 9 is a diagram showing an example of a security policy-setting screen displayed on the Web browser of the client PC.

FIG. 10 is a diagram showing an example of a policy database stored in an HDD of the image forming apparatus.

FIG. 11 is a diagram showing an example of a resetting incapability warning screen displayed on the Web browser of the client PC.

FIG. 12 is a sequence diagram of operations performed between the client PC and the image forming apparatus when the client PC accesses the image forming apparatus in a situation incapable of resetting the security policy.

FIG. 13 is a diagram showing an example of an access failure screen displayed on the Web browser of the client PC.

FIG. 14 is a sequence diagram of operations performed between the client PC and the image forming apparatus when the client PC accesses the image forming apparatus using an emergency port, due to incapability of resetting the security policy.

FIG. 15 is a diagram showing an example of a login screen displayed on the Web browser of the client PC, for security policy setting.

FIG. 16 is a flowchart of a security policy control process performed by a security policy controller of an image forming apparatus according to a second embodiment of the present invention.

FIG. 17 is a sequence diagram of operations performed between the client PC, the image forming apparatus, and a policy server, when the client PC accesses the image forming apparatus for setting a security policy, in a mode of acquiring a security policy from the server.

FIG. 18 is a diagram showing an example of a confirmation screen displayed on the Web browser of the client PC.

### DESCRIPTION OF THE EMBODIMENTS

The present invention will now be described in detail below with reference to the accompanying drawings showing embodiments thereof.

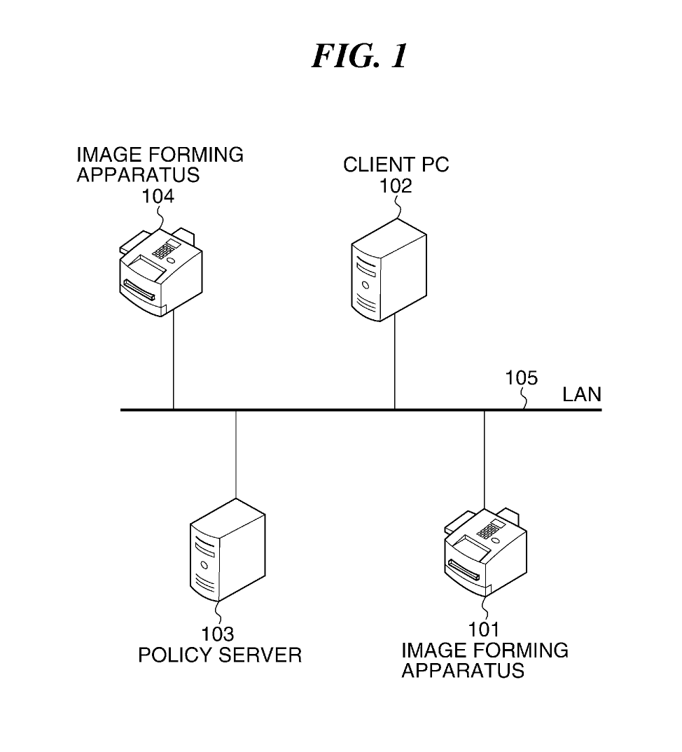

FIG. 1 is a diagram showing an example of a network environment in which an image forming apparatus according to a first embodiment of the present invention is installed.

Image forming apparatuses 101 and 104 as examples of the image forming apparatus according to the first embodiment, a client PC 102, and a policy server 103 are connected to a network 105, such as a LAN, and are in a communicable state.

In the illustrated network environment, a URL of the image forming apparatus 101 or 104 is input from a screen displayed on a Web browser of the client PC 102, and the security policy can be set from a security policy-setting screen displayed on the Web browser. Further, it is also possible to simultaneously distribute a security policy to the plurality of the image forming apparatuses 101 and 104 by making use of the policy server 103. Furthermore, the image forming apparatus 101 or 104 can also acquire a security policy by accessing the policy server 103.

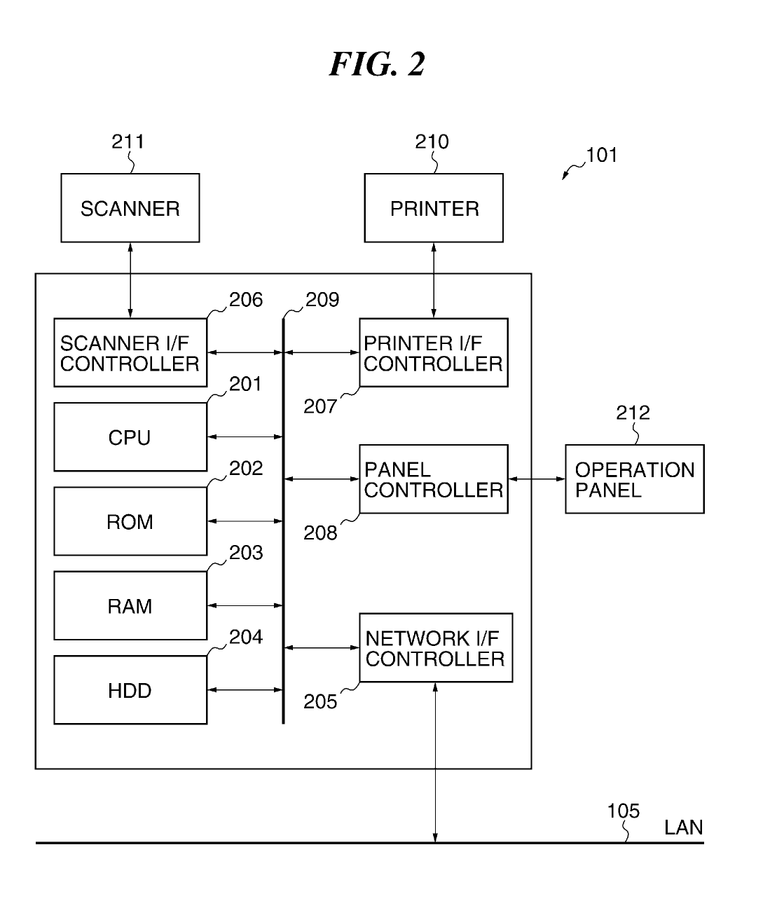

FIG. 2 is a block diagram of the hardware configuration of the image forming apparatus 101 appearing in FIG. 1. Note that the image forming apparatus 104 has the same hardware configuration as that of the image forming apparatus 101.

A CPU 201 executes software programs to thereby control the overall operation of the image forming apparatus 101. A ROM (read only memory) 202 stores a boot program, fixed parameters, and so forth of the image forming apparatus 101. A RAM (random access memory) 203 is used for temporarily storing data when the CPU 201 controls the image forming apparatus 101.

An HDD (hard disk drive) 204 stores various data, such as print data. A network interface controller 205 controls transmission and reception of data via the network 105.

A scanner interface controller 206 is an interface for controlling a scanner 211. A printer interface controller 207 is an interface for controlling a printer 210.

A panel controller 208 controls an operation panel 212 to display various information and receive an input of an instruction from a user.

The CPU 201, the ROM 202, the RAM 203, the HDD 204, the network interface controller 205, the scanner interface controller 206, the printer interface controller 206, and the panel controller 208 are connected to each other via a bus 209. The bus 209 is a system bus used for transmitting and receiving a control signal from the CPU 201 and data signals between the above-described components.

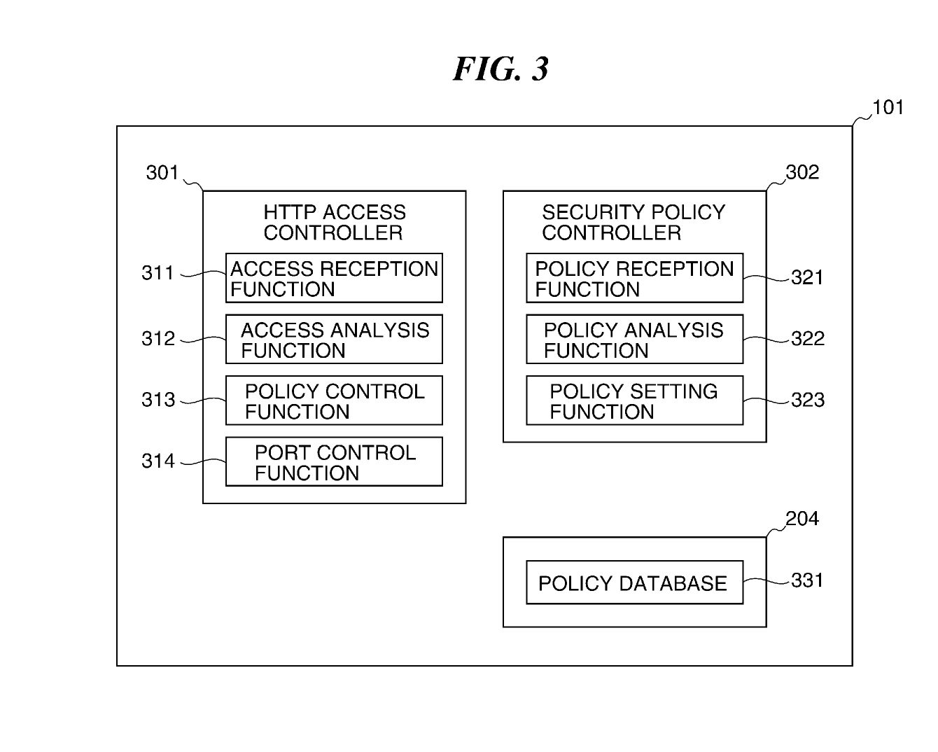

FIG. 3 is a block diagram of the software configuration of the image forming apparatus 101 appearing in FIG. 1. The illustrated example shows only software associated with the security policy.

An HTTP access controller 301 is a software program for controlling HTTP access, and has functions described as follows.

An access reception function 311 receives HTTP data when an HTTP access is made from a terminal on the network via the network interface controller 205. An access analysis function 312 analyzes the received HTTP data.

A policy control function 313 requests a security policy controller 302 to change a policy in a case where it is determined, based on a result of analysis of the received HTTP data by the access analysis function 312, that a policy change request has been received. A port control function 314 changes the port in a case where it is determined, based on a result of analysis of the HTTP data by the access analysis function 312, that a port change request has been received.

The security policy controller 302 is a software program for controlling the security policy, and has functions described as follows.

A policy reception function 321 receives a security policy from other programs including the HTTP access controller 301. A policy analysis function 322 analyzes the received security policy. A policy setting function 323 is a function for applying the received security policy.

The HTTP access controller 301 and the security policy controller 302 are stored in the ROM 202, and are loaded into the RAM 203 and executed by the CPU 201 when the CPU 201 controls the image forming apparatus 101. Further, a policy database 331 is stored in the HDD 204. The policy database 331 stores information on the security policy held by the image forming apparatus 101.

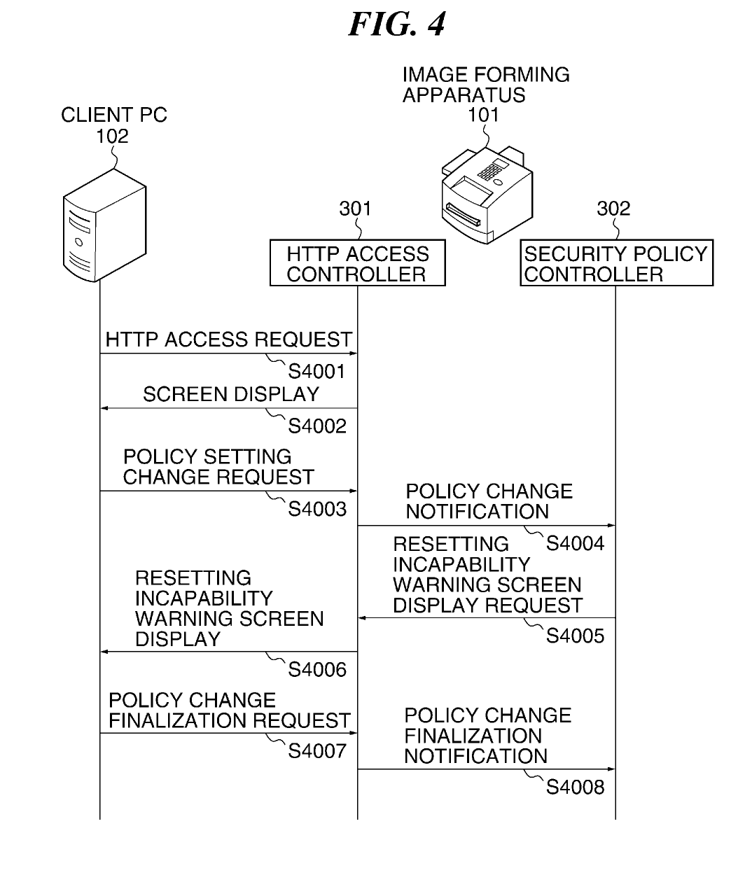

FIG. 4 is a sequence diagram of operations performed between the client PC 102 and the image forming apparatus 101 when the client PC 102 accesses the image forming apparatus 101 to change settings of a security policy. Note that operations performed by the image forming apparatus 101 include operations performed between the HTTP access controller 301 and the security policy controller 302 in response to the access.

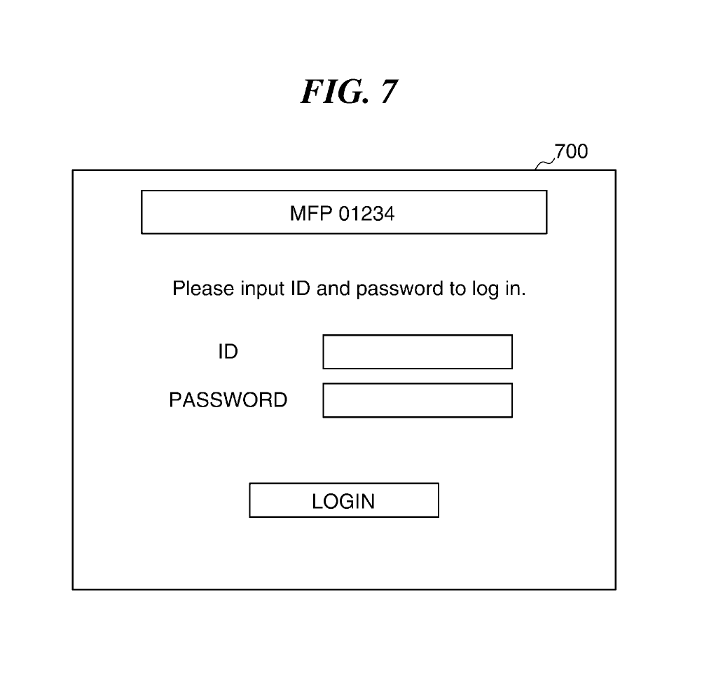

When a Web browser is started at the client PC 102 and a URL of the image forming apparatus 101 is input to a URL input box on a screen of the Web browser displayed on the client PC 102, the client PC 102 sends an HTTP access request to the image forming apparatus 101 (S4001). The HTTP access request sent in the step S4001 is a request for displaying a screen, and the HTTP access controller 301 analyzes the HTTP access request, and sends a response screen as a response (S4002). As a result, a login screen 700, shown in FIG. 7, is displayed on the Web browser of the client PC 102.

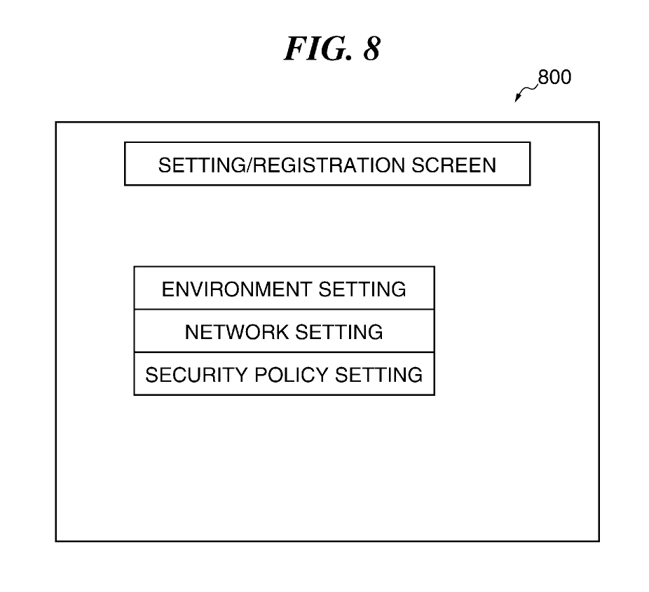

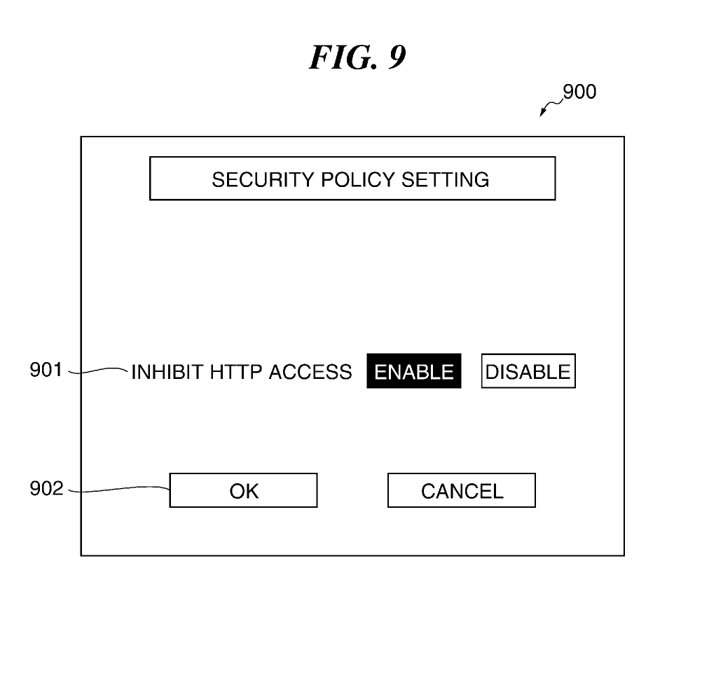

When a user ID and a password are input to the login screen 700 and a login button is pressed on the login screen 700, the screen is changed to a setting registration screen 800, shown in FIG. 8. When “security policy setting” is selected on the setting registration screen 800, the screen is changed to a security policy-setting screen 900, shown in FIG. 9. Although not shown in FIG. 4, whenever the screen is changed, the steps S4001 and S4002 are repeatedly executed.

Although various policies (setting values) of a security policy can be changed on the security policy-setting screen, in the present embodiment, a case where a policy inhibiting HTTP access is set will be described. When a setting of “inhibit HTTP access” 901 is set to “enable”, and an OK button 902 is pressed on the security policy-setting screen 900, the client PC 102 sends a policy setting change request to the image forming apparatus 101 (S4003).

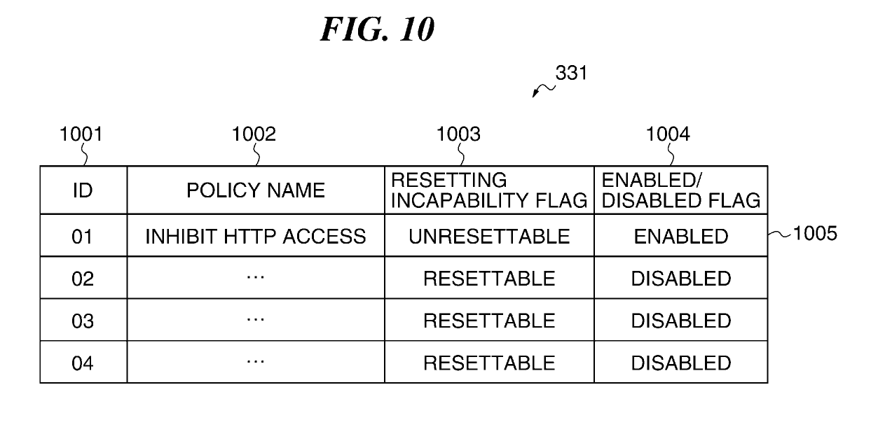

The HTTP access controller 301 analyzes the HTTP access request received from the client PC 102, and if it is determined that the HTTP access request is a policy setting change request, the HTTP access controller 301 sends a policy change notification to the security policy controller 302 (S4004). In the image forming apparatus 101, the security policy is managed using the policy database 331 shown in FIG. 10.

Referring to FIG. 10, the policy database 331 stores information of an ID 1001, a policy name 1002, a resetting incapability flag 1003, and an enabled/disabled flag 1004. For example, in association with ID “01”, there is registered policy information 1005 having the policy name set to “inhibit HTTP access”, the resetting incapability flag set to “unresettable”, and the enabled/disabled flag set to “enabled”.

The ID 1001 indicates an identifier for identifying a policy, and the policy name 1002 indicates a name of the policy. The resetting incapability flag 1003 indicates that a security policy including the policy becomes incapable of being reset via the network if the policy is enabled. This information is not set by a user, but is determined in advance by the security policy controller 302 and is registered in the policy database 331. The enabled/disabled flag 1004 is set to “enabled” or “disabled” when the policy is set by the policy setting function 323, and the set policy is applied to the image forming apparatus 101 when the enabled/disabled flag 1004 is set to “enabled”.

Referring back to FIG. 4, when the policy change notification is made in the step S4004, the security policy controller 302 analyzes the policy, and determines whether or not the policy is one which will make the security policy incapable of being reset. As a result of analysis, if it is determined that the security policy will be made incapable of being reset, in order to request the user to confirm whether the change is allowed to take effect even though it will be made impossible to reset the security policy, the security policy controller 302 requests the HTTP access controller 301 to display a resetting incapability warning screen (S4005).

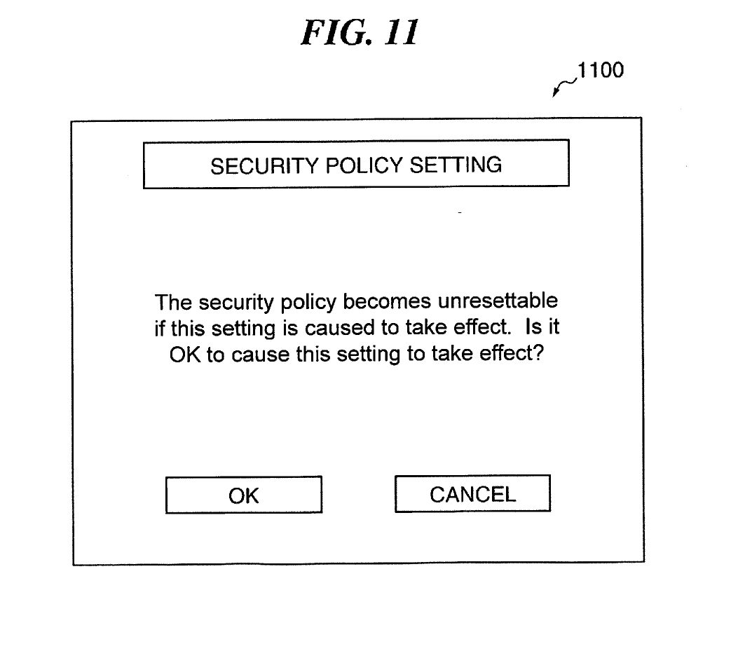

Upon receipt of a request for displaying the resetting incapability warning screen from the security policy controller 302, the HTTP access controller 301 sends the resetting incapability warning screen as a response to the HTTP request (policy setting change request) received in the step S4003 (step S4006) to the requestor. This causes the resetting incapability warning screen, denoted by reference numeral 1100, shown in FIG. 11, to be displayed on the Web browser of the client PC 102. As described above, the warning to the effect that the security policy becomes incapable of being reset by setting the policy is displayed, and when an OK button is pressed, the client PC 102 sends a policy change finalization request to the HTTP access controller 301 (S4007).

Upon receipt of the policy change finalization request from the client PC 102, the HTTP access controller 301 closes the currently used port, and opens a port for emergency. The reason for changing the port is to make it possible to perform resetting of a security policy, by a special access method, in a case where e.g. a policy of inhibiting HTTP access, which makes it impossible to reset a security policy, takes effect. Normally, although an 80th port is used for HTTP access, since HTTP access is inhibited, the 80th port is closed. In the present embodiment, by opening a special port number for emergency, it is possible to continue only the security policy setting. As the port for emergency, a fixed port may be opened on the premise that an administrator knows it in advance, or the port number may be notified to a registered mail address of the administrator. In the present embodiment, the description will be given assuming the former case in which the fixed port is opened. Thereafter, the HTTP access controller 301 sends a policy change finalization notification to the security policy controller 302 (S4008). When the policy change finalization is notified in the step S4008, the security policy controller 302 applies the policy to the apparatus.

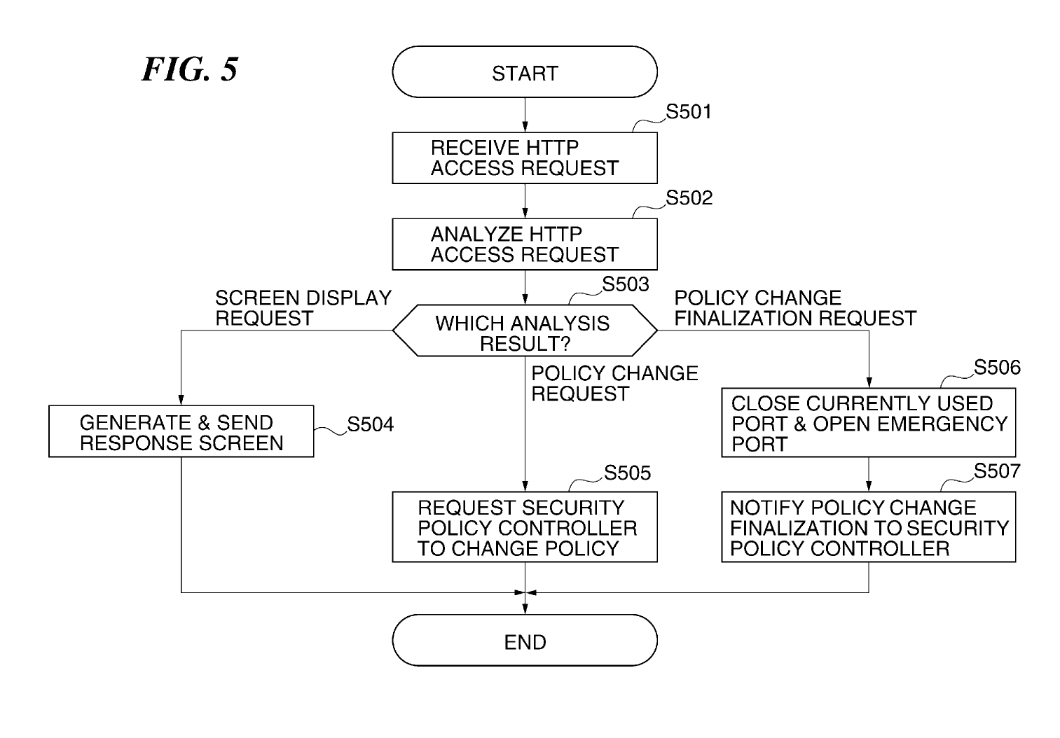

Next, the HTTP access control process performed by the HTTP access controller 301 in FIG. 4 will be described with reference to FIG. 5.

FIG. 5 is a flowchart of the HTTP access control process performed by the HTTP access controller 301.

In the HTTP access controller 301, the access reception function 311 receives an HTTP access request (step S501), and the access analysis function 312 analyzes the received HTTP access request (step S502). The access analysis function 312 determines processing to be performed next, based on the analysis result (step S503), and if it is determined that the received request is a request for displaying a screen, the HTTP access controller 301 generates a response screen, and sends the generated screen to the requestor as a response (step S504). If it is determined in the step S503 that the received request is a policy change request, the policy control function 313 requests the security policy controller 302 to change a policy (step S505). If it is determined in the step S503 that the received request is a policy change finalization request, the port control function 314 closes the currently used port, and opens the port for emergency (step S506). Thereafter, the policy control function 313 notifies the policy change finalization to the security policy controller 302 (step S507).

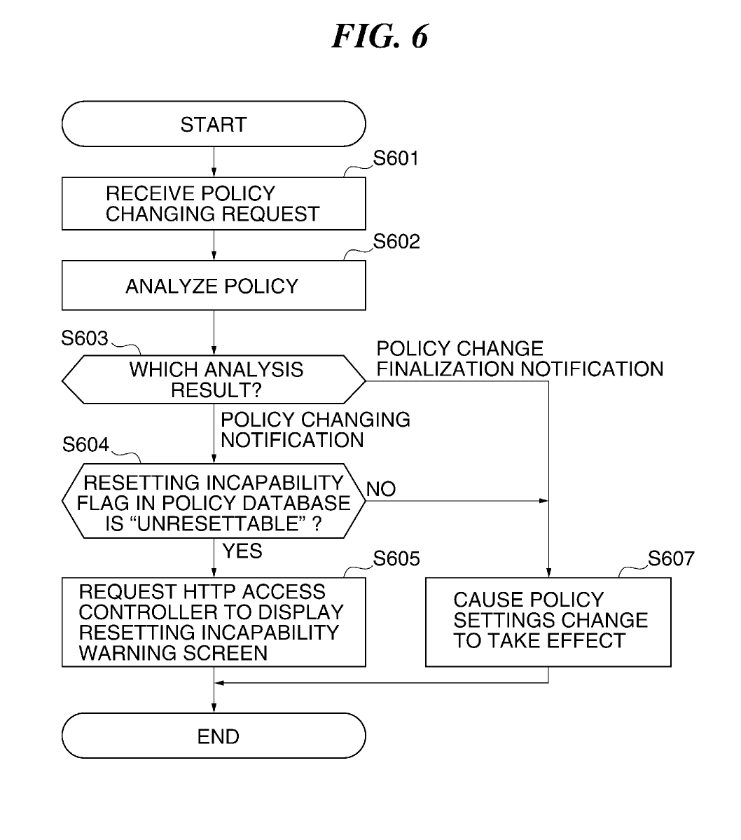

Next, the security policy control process performed by the security policy controller 302 in FIG. 4 will be described with reference to FIG. 6.

FIG. 6 is a flowchart of the security policy control process performed by the security policy controller 302.

In the security policy controller 302, the policy reception function 321 receives a policy change request (step S601), and the policy analysis function 322 analyzes the received policy change request (step S602). The policy analysis function 322 determines processing to be performed next, based on the analysis result (step S603), and if it is determined that the received request is a policy change notification, the security policy controller 302 executes processing for checking the resetting incapability flag 1003 of the received policy, registered in the policy database 331 (step S604). As a result, if the resetting incapability flag 1003 is set to “resettable”, the security policy controller 302 causes the change of the policy setting to take effect without displaying the above-mentioned warning (step S607). On the other hand, if the resetting incapability flag 1003 is set to “unresettable”, the security policy controller 302 requests the HTTP access controller 301 to display the warning for requesting the user to confirm whether the change may be caused to take effect even though the security policy becomes unresettable (step S605). At this time, although not shown in FIG. 5, in the HTTP access controller 301, the policy control function 313 receives the request, and generates and sends the resetting incapability warning screen as a response to the HTTP request received in the step S4003.

If it is determined in the step S603 that the received request is the policy change finalization notification, the policy setting function 323 changes the enabled/disabled flag 1004 in the policy database 331, shown in FIG. 10, to “enabled”, and causes the change of the policy setting to take effect (step S607).

Next, the access operation performed between the client PC 102 and the image forming apparatus 101 when inhibition of HTTP access is set by the above-described setting change of the security policy will be described.

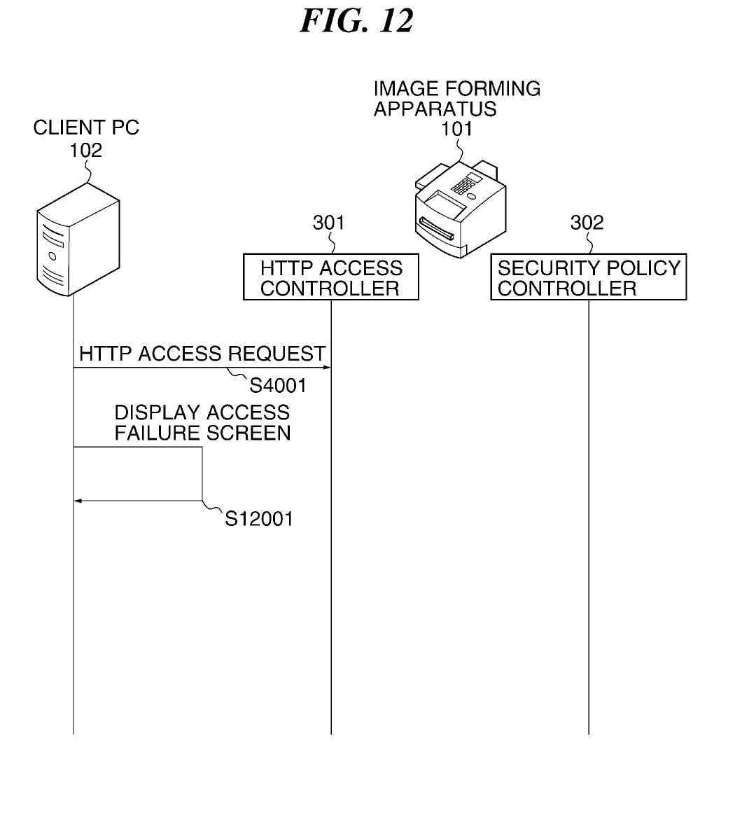

FIG. 12 is a sequence diagram of operations performed between the client PC 102 and the image forming apparatus 101 when the client PC accesses the image forming apparatus in a situation incapable of resetting the security policy.

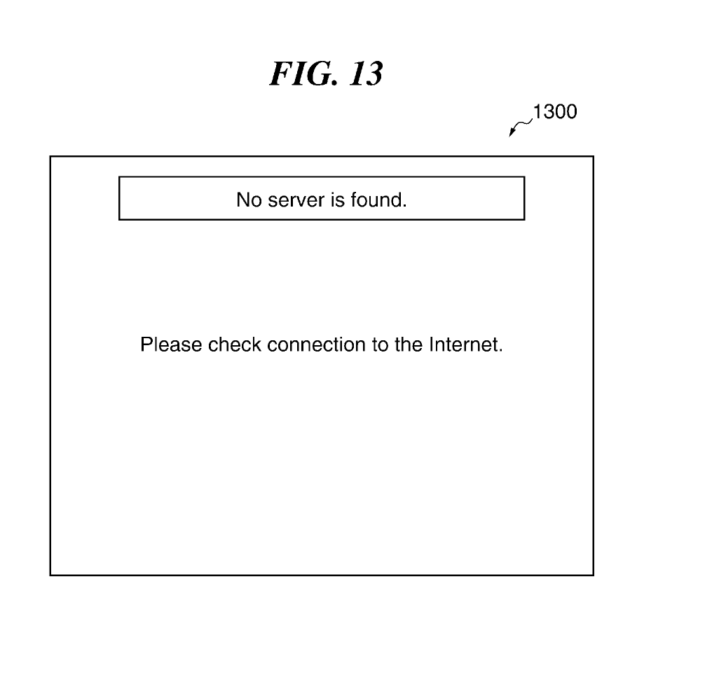

When the Web browser is started from the client PC 102 and the IP address of the image forming apparatus 101 is input in the URL input box, the client PC 102 sends an HTTP access request to the image forming apparatus 101 (S4001). Normally, when the image forming apparatus 101 is accessed by inputting the IP address on the Web browser, the 80th port is used for HTTP access. The 80th port is closed when HTTP access is inhibited, and hence the HTTP access controller 301 cannot receive this HTTP request. Therefore, the Web browser is timed out, and as shown in FIG. 13, an inaccessibility screen 1300 having a message to the effect that access has failed is displayed (S12001).

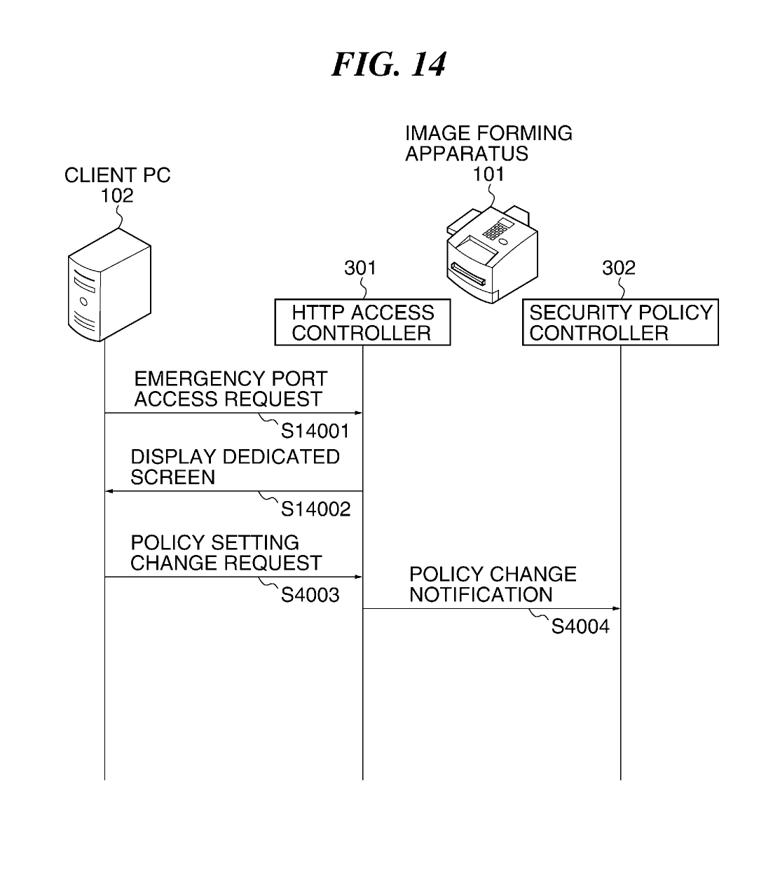

FIG. 14 is a sequence diagram of operations performed between the client PC 102 and the image forming apparatus 101 when the client PC 102 accesses the image forming apparatus 101 using an emergency port, due to incapability of resetting the security policy.

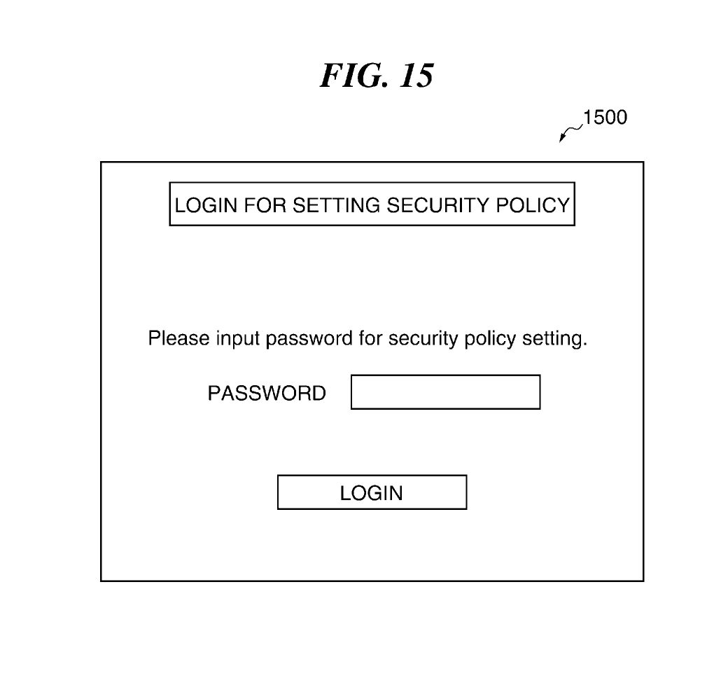

When the Web browser is started at the client PC 102 and the IP address and the emergency port number of the image forming apparatus 101 are input in the URL input box, the client PC 102 sends an HTTP access request to the image forming apparatus 101 (S14001). For example, in this step, when the IP address is 192.168.0.11 and the emergency port number of the image forming apparatus 101 is 1234, the image forming apparatus 101 is accessed using an URL http://192.168.0.1:1234 in which the port number is directly designated. As a screen displayed at this time, the login screen 700 shown in FIG. 7 is displayed when normal access is executed, but when the image forming apparatus 101 is accessed using the emergency port, a login screen 1500 for setting a security policy, shown in FIG. 15, is displayed so as to cause the user to perform only resetting of the security policy (S14002). When a correct password is input on this screen, the screen is changed to the security policy-setting screen 900 shown in FIG. 9.

To cancel a state in which the security policy is unresettable, the policy “inhibit HTTP access” 901 is set to “disable”, and then the OK button 902 is pressed. As a result, the client PC 102 sends a policy setting change request to the image forming apparatus 101. The processes performed at this time by the HTTP access controller 301 and the security policy controller 302 are the same as those executed in the normal state, and the policy setting request in the step S4003 and the policy change notification in the step S4004 are sent in the same manner.

As described above, according to the present embodiment, even in the case where the security policy has become unresettable, by accessing the emergency port set in advance, it is possible to reset the security policy via the network.

Next, a description will be given of a second embodiment of the present invention.

The second embodiment differs from the first embodiment in that in the case where the security policy has become unresettable, the image forming apparatus 101 is automatically changed to a mode of acquiring the security policy from an external server. The processes executed when changing the setting of the security policy are the same as the steps S4001 to S4008 in FIG. 4. However, the operations performed at the time by the HTTP access controller 301 and the security policy controller 302 are different, and hence the different points will be described.

In the first embodiment, when the policy change finalization request is sent from the client PC 102 to the image forming apparatus 101 in the step S4007 in FIG. 4, the HTTP access controller 301 closes the currently used port in the step S506 in FIG. 5, and opens the emergency port. In the second embodiment, this processing is not executed.

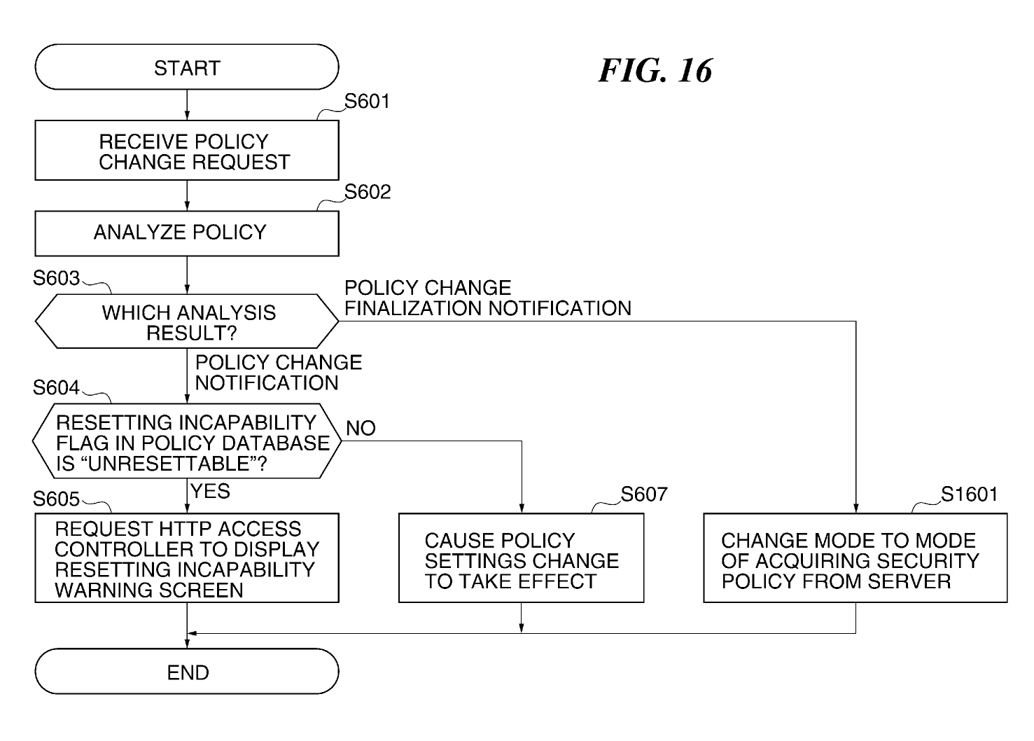

FIG. 16 is a flowchart of a security policy control process performed by the security policy controller 302 of the image forming apparatus 101 according to the second embodiment. In the illustrated process, the same steps as those in FIG. 6 are denoted by the same step numbers, and description thereof is omitted.

When the policy change finalization is notified in the step S4008 in FIG. 4, and hence if it is determined based on the result of analysis of the received policy change request by the policy analysis function 322 in the step S603 in FIG. 16 that the received request is the policy change finalization notification, the security policy controller 302 executes processing for changing the mode to the mode of acquiring the security policy from the server (step S1601). The mode of acquiring the security policy from the server is a mode of periodically requesting the policy server 103 to update the security policy, differently from the mode of receiving a change in the settings of the security policy from the Web browser or the like of a client PC as described above as to the first embodiment.

To cope with the problem that the security policy becomes incapable of being reset due to a setting (policy) change of inhibiting HTTP access, in the present embodiment, a security policy in which HTTP access inhibition is disabled is stored in the policy server 103 in advance. Then, the image forming apparatus 101 periodically accesses the policy server 103 to thereby update the security policy set to the image forming apparatus 101. Note that although it is desired that the image forming apparatus 101 periodically accesses the policy server 103 at a predetermined time of day set in advance, this is not limitative.

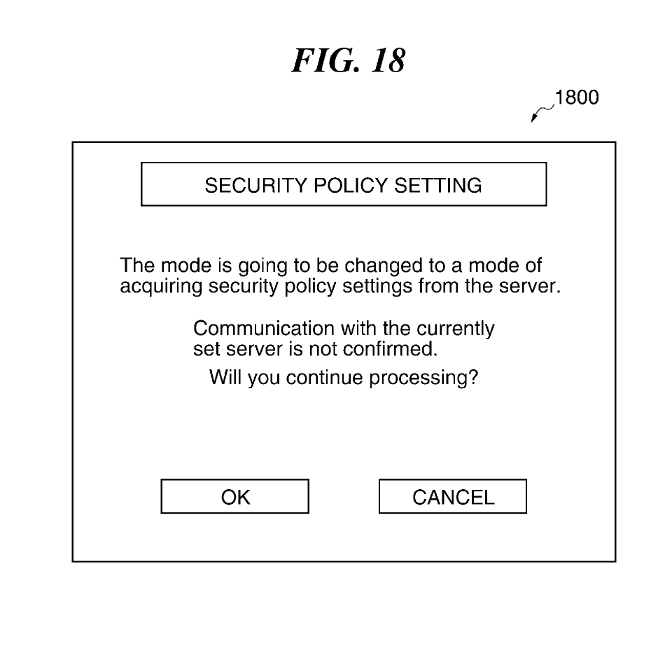

By the way, in a case where the policy server 103 is not in operation when the image forming apparatus 101 accesses the policy server 103, a security policy setting confirmation screen 1800, shown in FIG. 18, is displayed. The security policy setting confirmation screen 1800 displays an inquiry to the user about whether or not to continue processing in a case where communication with the policy server 103 cannot be confirmed even when the mode is changed to the mode of acquiring the security policy from the server. This re-warning process is the same as the steps S4005 to S4007 in FIG. 4.

Further, the setting of the security policy can also be changed from the operation panel 212. For example, in the case where the resetting incapability flag 1003 is set to “unresettable” only with respect to the policy “inhibit HTTP access”, as registered in the policy database 331 shown in FIG. 10, it is possible to make the security policy resettable by disabling the policy of HTTP access inhibition. At this time, the operation mode is changed not to the mode of acquiring the security policy from the server, but to the mode of receiving a setting change from the outside.

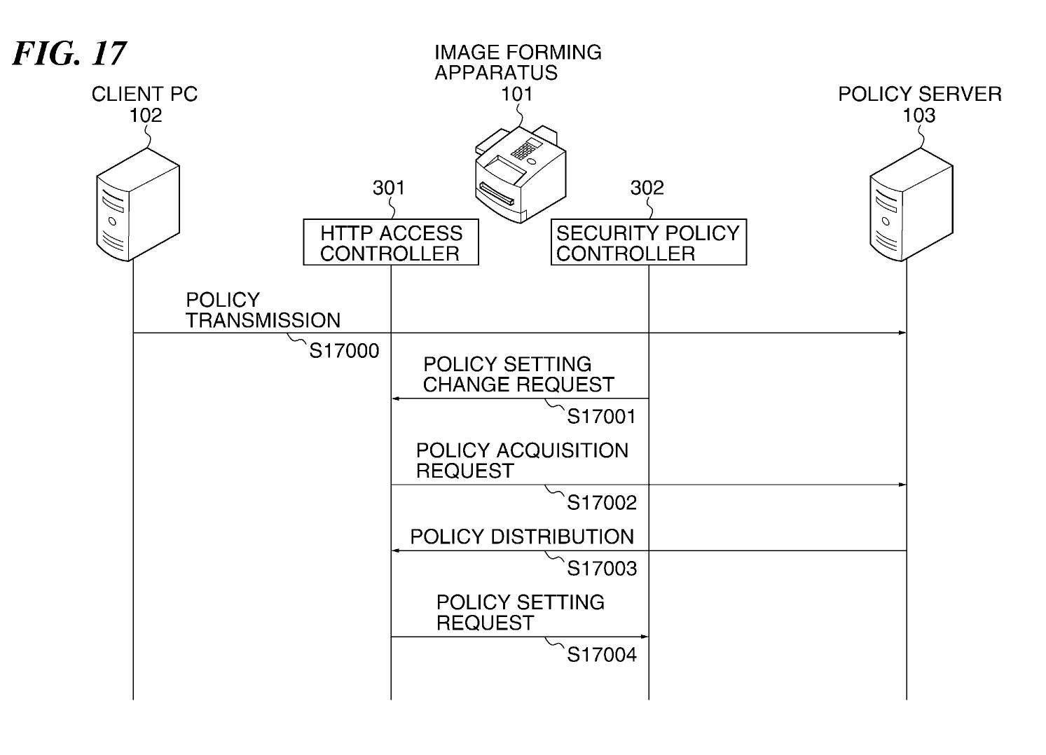

FIG. 17 is a sequence diagram of operations performed between the client PC102, the image forming apparatus 101, and the policy server 103, when the client PC 102 accesses the image forming apparatus for setting a security policy, in the mode of acquiring the security policy from the server.

In a case where the security policy has become unresettable, the client PC 102 transmits a policy file based on which resetting of the security policy is desired to be performed, to the policy server 103 (step S17000). The policy file is formed as a file describing setting values of the security policy, in which the setting values are equivalent to those written in the format of the policy database 331 shown in FIG. 10. The values of the ID 1001, the policy name 1002, and the resetting incapability flag 1003, which are the setting values of the policy file, are determined in advance, and cannot be changed. It is the setting value of the enabled/disabled flag 1004 that can be changed. For example, when the policy “inhibit HTTP access” in the policy information 1005 is enabled to thereby make the security policy unresettable, it is possible to cancel the state where the security policy is unresettable by transmitting a policy file in which the policy “inhibit HTTP access” is disabled, to the policy server 103.

A time of day to acquire a policy file from the policy server, and so forth, can be set in the policy file. When the time of day at which the image forming apparatus 101 acquires the policy file from the policy server 103 is set to e.g. 00:00 AM (midnight) in the policy file, the image forming apparatus 101 having received this policy file changes the time of day at which it is to access the policy server 103.

When it is the time of day set in advance, the security policy controller 302 sends a policy setting change request to the HTTP access controller 301 so as to update the security policy (step S17001).

Upon receipt of the policy setting change request, the HTTP access controller 301 sends a policy acquisition request to the policy server 103 (step S17002).

Upon receipt of the policy acquisition request from the HTTP access controller 301, the policy server 103 searches for a policy file applicable to the image forming apparatus 101, and distributes the applicable policy file to the image forming apparatus 101 (step S17003).

Upon receipt of the policy file from the policy server 103, the HTTP access controller 301 sends a policy setting request to the security policy controller 302 (step S17004).

Upon receipt of the policy setting request from the HTTP access controller 301, the security policy controller 302 causes the security policy to be changed according to the settings of the policy file.

As described above, according to the present embodiment, a policy file of a security policy which is resettable is stored in the policy server 103 in advance. Then, in a case where the security policy set for the image forming apparatus 101 has become incapable of being reset, the image forming apparatus 101 is changed to the mode of acquiring the security policy from the server. Then, the security policy of the image forming apparatus 101 is updated to a resettable security policy acquired from the policy server 103. Thus, it is made possible to reset the security policy via the network.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-217689 filed Oct. 18, 2013, which is hereby incorporated by reference herein in its entirety.

What is claimed is:

1. An image forming apparatus comprising:
a reception unit configured to receive an access request from an outside;
a first analysis unit configured to analyze the access request received by said reception unit; and
a control unit configured to open a second port which is different from a first port currently used by said reception unit, in a case where it is determined by said first analysis unit that the access request is a request for finalizing a change to a security policy which is made unresettable.

2. The image forming apparatus according to claim 1, wherein the security policy which is made unresettable includes at least a policy that inhibits HTTP access.

3. The image forming apparatus according to claim 1, wherein when said reception unit receives a security policy which is resettable using the second port, said control unit changes the security policy which has become incapable of being reset to the security policy which is resettable.

4. An image forming apparatus comprising:
a reception unit configured to receive an access request from an outside;
a first analysis unit configured to analyze the access request received by said reception unit; and
a control unit configured to acquire a security policy which is resettable, from the outside, in a case where it is determined by said first analysis unit that the access request is a request for finalizing a change to a security policy which is made unresettable.

5. The image forming apparatus according to claim 4, wherein said control unit periodically acquires the security policy which is resettable from a server storing the security policy which is resettable, and changes the security policy which has become incapable of being reset to the security policy which is resettable.

6. The image forming apparatus according to claim 1, further comprising a second analysis unit configured to analyze, in a case where it is determined by said first analysis unit that the access request is a request for changing a security policy, the security policy to be changed; and
a warning unit configured to send a warning to a requestor of the access request in a case where it is determined by said second analysis unit that a security policy to which the security policy is to be changed is a security policy which is made unresettable.

7. A method of controlling an image forming apparatus, comprising:
receiving an access request from an outside;
analyzing the access request received by said receiving; and
opening a port which is different from a port currently used by said receiving, in a case where it is determined by said analyzing that the access request is a request for finalizing a change to a security policy which is made unresettable.

8. A method of controlling an image forming apparatus, comprising:
receiving an access request from an outside;
analyzing the access request received by said receiving; and
acquiring a security policy which is resettable from the outside, in a case where it is determined by said analyzing that the access request is a request for finalizing a change to a security policy which is made unresettable.

9. A non-transitory computer-readable storage medium storing a computer-executable program for executing a method of controlling an image forming apparatus,
wherein the method comprises:
receiving an access request from an outside;
analyzing the access request received by said receiving; and
opening a port which is different from a port currently used by said receiving, in a case where it is determined by said analyzing that the access request is a request for finalizing a change to a security policy which is made unresettable.

10. A non-transitory computer-readable storage medium storing a computer-executable program for executing a method of controlling an image forming apparatus,
wherein the method comprises:
receiving an access request from an outside;
analyzing the access request received by said receiving; and
acquiring a security policy which is resettable from the outside, in a case where it is determined by said analyzing that the access request is a request for finalizing a change to a security policy which is made unresettable.
